(19) United States
(12) Patent Application Publication
(10) Pub. No.: US 2025/0010549 A1
(43) Pub. Date: Jan. 9, 2025

(54) 3-DIMENSIONAL PRINT REMOVAL DEVICE USING NON-DESTRUCTIVE FORCE TECHNOLOGY

(71) Applicant: Ronald Sacdalan, Shelton, WA (US)

(72) Inventor: Ronald Sacdalan, Shelton, WA (US)

(21) Appl. No.: 18/219,165

(22) Filed: Jul. 7, 2023

(51) Int. Cl. B29C 64/379; B33Y 40/00

(52) U.S. Cl. CPC B29C 64/379; B33Y 40/00

(57) ABSTRACT

A device for removing a 3D printed item from the build plate of a 3D printer is disclosed, the device including a body housing one or more springs biased force an impact rod to extend therefrom. A nose element extends from a front portion of the body to aid in removing a 3D printed item from a build plate of a 3D printer. The nose element is coupled to the impact rod to permit the nose element to extend into the extended position and provide a non-destructive force to the 3D printed item.

### TECHNICAL FIELD

The embodiments disclosed herein generally relate to devices and methods for removing a 3-Dimensionally (3D) printed model from the build plate of a fused deposition modeling (FDM) printing system.

### BACKGROUND

3D printing is a process of making three-dimensional solid objects from a digital file. The creation of a 3D printed object is achieved using additive processes. In an additive process, an object is created by laying down successive layers of material until the object is created. There are several types of 3D printing technologies available today, including vat photopolymerization, material jetting, binder jetting, powder bed fusion, material extrusion, directed energy deposition, and sheet lamination. Each 3D printing technology has its own unique advantages and disadvantages. 3D printers are used in various fields such as architecture, engineering, medicine, and art. They can be used to create prototypes of products before they are mass-produced or to create customized products for individual customers.

Fused Deposition Modeling (FDM) is a 3D printing technology that involves building a physical part layer by layer using plastic filaments that are extruded from a nozzle. FDM is also known as fused filament fabrication (FFF) and is an additive manufacturing process within the realm of material extrusion.

The two most common filaments used for 3D printers are acrylonitrile butadiene styrene (ABS) and polylactic acid (PLA). Most basic 3D printers are designed to exclusively use these filaments. ABS is a thermoplastic that is strong, durable, and heat-resistant. It is commonly used in the automotive and toy industries. PLA is a biodegradable thermoplastic that is made from renewable resources such as cornstarch or sugarcane. It is easy to print with and produces less warping than ABS.

The range of designs that can be printed using FDM is quite versatile. A 3D printer can be used to print complex geometries as well as simple housings and fixtures. FDM 3D printing is a manufacturing technology in which a 3D printer lays molten plastic material in layers to create an object. It is also known as additive manufacturing because material is being added to build something, instead of it being removed from a workpiece.

The build plate of a 3D printer is the flat surface on which the first layer of the molten filament is deposited. It provides stability and dimension accuracy for the entire project even if it only really comes in contact with the first (base) layer of the printed 3D model. The build plate is an essential component of a 3D printer and can be made from various materials such as glass, aluminum, or plastic.

The process of FDM 3D printing requires that the initial layer of molten filament adhere well enough to the 3D printer build plate to prevent the 3D model from shifting out of place during the filament extrusion process. The process of 3D printing a single model can consume many hours as the filament is applied, layer by layer, to build up the material into the desired form.

The slightest shift of the 3D model during the layering process will cause the print job to fail, resulting in filament extruding uncontrollably over the 3D printed model and build plate. To this end, it is necessary that the initial layer adhere well to the 3D printer build plate.

The ultimate conundrum of 3D printing is that a 3D print that adheres well to the printer build plate may also be difficult to separate from said build plate when the layering process is completed.

One of the most common issues with 3D printing is getting the print to stick to the build plate. There are several reasons why a 3D print may not adhere sufficiently to the build plate, including an unlevel build plate, incorrect bed temperature, or poor bed adhesion. To fix this issue, there are several methods that are currently used to attempt to separate a 3D print from the 3D printer build plate. First, make sure the build plate is level. If not level, the 3D print may not adhere properly to the surface. Also tried are adhesion agents such as hairspray or glue sticks on the build plate to help the print adhere sufficiently. Another option is to increase the bed temperature slightly to help the plastic adhere better.

Removing a stuck 3D print from the build plate can be a frustrating experience. The following are common procedures to remove 3D prints from the 3D printer build plate: Scraping: A scraper or spatula can be used to try to pry the print off the build plate. Warm up the print bed: If the print is stuck to the bed, warming up the bed to soften the plastic is an option. This may make it easier to remove the print but may cause slight deformation of the print. Use dental floss: If the 3D print is stuck to the bed and a scraper or spatula has not worked, dental floss might be utilized. Hold the floss with two hands and run it at the bottom rear of the model pulling it towards you slowly. Place the build plate and 3D print in a cool place: This will cause the plastic to contract slightly and may make it easier to remove the print.

### SUMMARY OF THE INVENTION

This summary is provided to introduce a variety of concepts in a simplified form that is further disclosed in the detailed description of the embodiments. This summary is not intended for determining the scope of the claimed subject matter.

In general, the embodiments provided herein relate to a device for removing a 3D printed item from the build plate of a 3D printer is disclosed, the device including a body housing one or more springs biased force an impact rod to extend therefrom. A nose element extends from a front portion of the body to aid in removing a 3D printed item from a build plate of a 3D printer. The nose element is coupled to the impact rod to permit the nose element to extend into the extended position and provide a non-destructive force to the 3D printed item.

In one aspect, the one or more springs force the impact rod into the 3D printed item to provide the non-destructive force and remove the 3D printed item from the build plate of the 3D printer.

In one aspect, the nose element comprises a front edge and a curved portion. The front edge and the curved portion aid in removing the 3D printed element from the build plate of the 3D printer.

In one aspect, a thumb rest provides stability when extending the nose element.

In one aspect, a body cover shields the one or more springs and provide a surface area for the thumb rest.

In one aspect, one or more spring posts each attach to each of the one or more springs. A spring post tab coupled to the one or more springs to each spring tab.

The present embodiments address the issue of 3D printed models that adhere too well to the 3D printer build plate, making it difficult to remove from said build plate. The embodiments are configured to separate the 3D print from the 3D printer build plate instantly and non-destructively, with little effort using the transference of kinetic energy to release a stuck 3D print from the build plate.

In some aspects, the embodiments are mechanical and non-electronic, however, future iterations may utilize electronic means to actuate the mechanical events necessary for the force transference needed to separate a 3D print from the build plate.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a perspective view of the 3D printed model removal device, according to some embodiments;

FIG. 2 illustrates a perspective view of the 3D printed model removal device having the impact rod in an extended configuration, according to some embodiments;

FIG. 3 illustrates an exploded view of the 3D print model removal device, according to some embodiments; and

FIG. 4 illustrates a perspective view of the 3D print model removal device removing the 3D model from the build plate of the 3D printer, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relates to a mechanical devices used to separate a 3D printed model (which may hereinafter be referred to as “item”, “3D print” or “3D printed item”) from the 3D printer build plate. The problem addressed by the present embodiments is the common issue of completed 3D prints sticking to the 3D printer build plate to the extent that the completed 3D print cannot easily be removed from the 3D printer build plate.

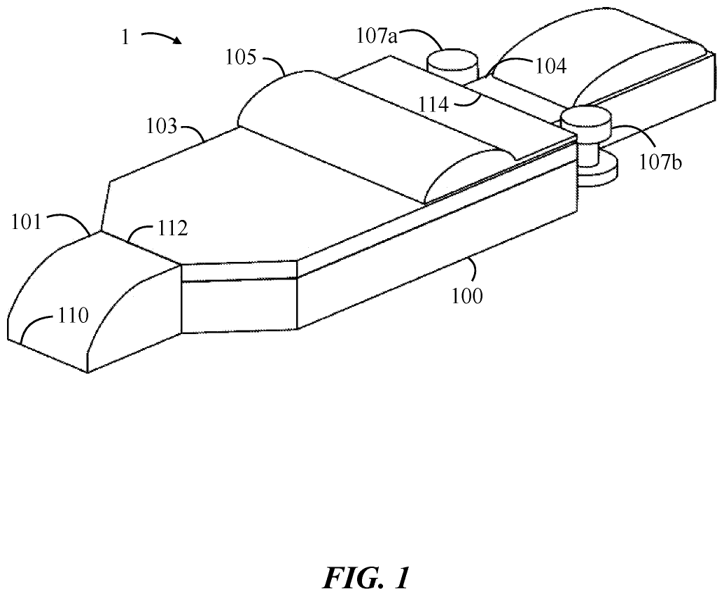

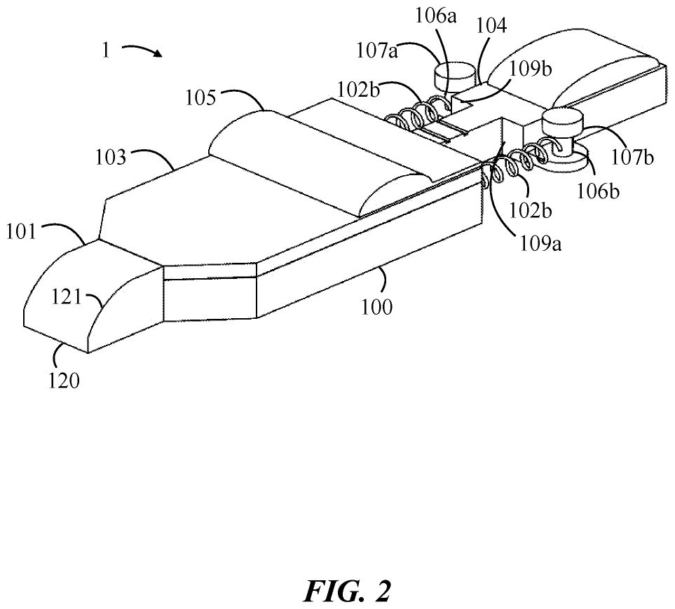

FIG. 1 illustrates a perspective view of the 3D printed model removal device 1. The mechanical elements of the present invention consist of a Body 100 with Nose element 101, Impact Rod 104, and Springs 102a, 102b (see FIG. 2). The Body 100 features a Nose element 101 at the front 110 of the device and extends from the front portion 112 of the Body 100. The Nose Element 101 comprised of a solid, firm, ridged material such as, but not limited to, PLA or ABS plastics. The Impact Rod 104 extends from a rear portion 114 of the Body 100.

FIG. 2 illustrates a perspective view of the 3D printed model removal device having the impact rod 104 in an extended configuration. Spring Posts 106a, 106b connect to the ends of the Springs 102a, 102b and are fastened to Spring Post Tabs 107a, 107b to secure the Springs 102a, 102b onto Spring Posts 106a, 106b. The Body Cover 103 shields the Springs 102a, 102b and provide surface area for the Thumb Rest 105 which provides stability. The Impact Rod 104 is tensioned with Springs 102a, 102b. Stoppers 109a, 109b stop the retraction of the Impact Rod 104 when in the retracted configuration (see FIG. 1) such that the Impact Rod 104 is retained in a position which can then be extended by the user during use.

The Nose Element 101 includes a front edge 120 and curved portion 121. The front edge 120 is positioned at the edge of the 3D printed item and is pressed into the edge of the 3D printed item to peel the 3D printed item from the build plate of the 3D printer. The curved portion 121 aid in further peeling and removing the 3D printed item from the build plate of the 3D printer.

To operate the device 1, the Nose 101 element of the Body 100 is pressed lightly against the base of a 3D printed model which is adhered to a 3D printer build plate. The Impact Rod 104 is pulled back with the User's fingers. Typically, this pull distance is less than one-inch to facilitate the necessary potential kinetic energy to remove a 3D print from the 3D printer build plate. The Impact Rod 104 is released and is pulled forward via the tension of the Springs 102a, 102b. The Impact Rod 104 impacts the internal aft Nose 101 element of the Body 100. The kinetic energy is transferred from the Impact Rod 104 to the Body 100, via the Nose 101 section, then finally to the stuck 3D print. The stuck 3D print is released from the 3D printer build plate.

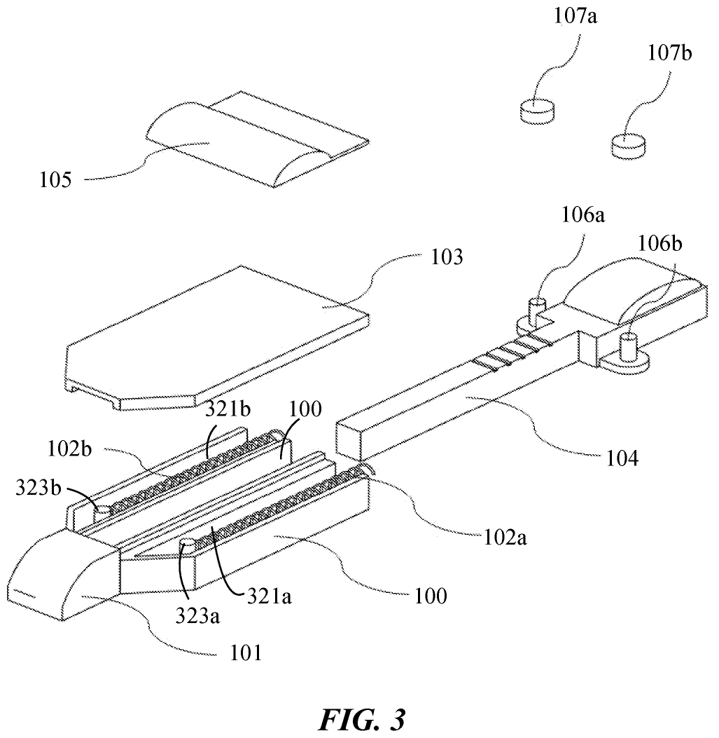

FIG. 3 illustrates an exploded view of the 3D print model removal device. The Springs 102a, 102b are contained within the interior 300 of the Body 100 when in the retracted position (see FIG. 1) and extend from the interior 300 of the body 100 when in the extended configuration (see FIG. 2). The interior 300 includes a channel 310 which allows the Impact Rod 104 to travel therethrough during the 3D printed item removal procedure. Each spring 102a, 102b is housed within spring channels 321a, 321b and connected to an anchor 323a,323b at the front of the body 100.

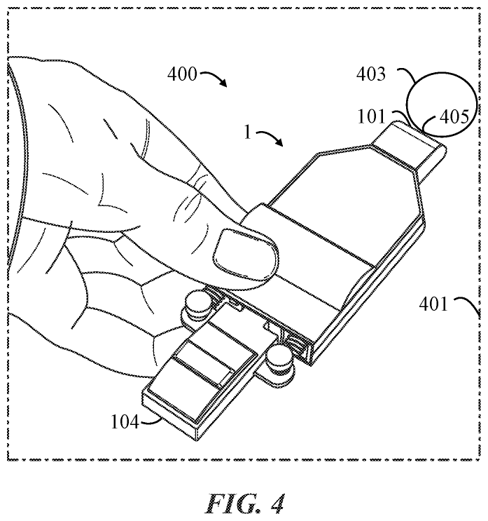

FIG. 4 illustrates a perspective view of the 3D print model removal device 1 removing the 3D model 403 from the build plate 400 of the 3D printer 401. The Nose 101 is contacted to an edge 405 of the 3D model 403 during the removal procedure described above. In summary, once the Nose 101 is contacted to edge 405, the Impact Rod 104 is pulled and released to remove the 3D model 403 from the build plate 400.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety to the extent allowed by applicable law and regulations. The systems and methods described herein may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

The foregoing is provided for purposes of illustrating, explaining, and describing embodiments of this disclosure. Modifications and adaptations to these embodiments will be apparent to those skilled in the art and may be made without departing from the scope or spirit of this disclosure.

As used herein and in the appended claims, the singular forms “a”, “an”, and “the” include plural referents unless the context clearly dictates otherwise.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic intervening entities) and the indirect coupling of two entities (with one or more non-negligible intervening entities). Where entities are shown as being directly coupled together or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described herein. A variety of modifications and variations are possible in light of the above teachings without departing from the following claims.

What is claimed is:

1. A device for removing a 3D printed item from the build plate of a 3D printer, the device comprising:
a body housing one or more springs biased force an impact rod to extend therefrom;
a nose element extending from a front portion of the body, the nose element to aid in removing a 3D printed item from a build plate of a 3D printer, the nose element coupled to the impact rod to permit the nose element to extend into the extended position and provide a non-destructive force to the 3D printed item.

2. The device of claim 1, wherein the nose element comprises a front edge.

3. The device of claim 2, wherein the nose element comprise a curved portion.

4. The device of claim 3, wherein the front edge and the curved portion aid in removing the 3D printed element from the build plate of the 3D printer.

5. The device of claim 1, further comprising a thumb rest to provide stability when extending the nose element.

6. The device of claim 5, further comprising a body cover to shield the one or more springs and provide a surface area for the thumb rest.

7. The device of claim 1, further comprising one or more spring posts to each attach to each of the one or more springs.

8. The device of claim 7, further comprising a spring post tab to couple the one or more springs to each spring tab.

9. A device for removing a 3D printed item from the build plate of a 3D printer, the device comprising:
a body housing one or more springs biased force an impact rod to extend therefrom;
a nose element extending from a front portion of the body, the nose element to aid in removing a 3D printed item from a build plate of a 3D printer by contacting the 3D printed item prior to pulling the impact rod rearward and releasing the impact road to force the nose element, via the one or more springs towards the 3D printed item, the nose element coupled to the impact rod to permit the nose element to extend into the extended position and provide a non-destructive force to the 3D printed item.

10. The device of claim 9, wherein the one or more springs force the impact rod into the 3D printed item to provide the non-destructive force and remove the 3D printed item from the build plate of the 3D printer.

11. The device of claim 9, wherein the nose element comprises a front edge.

12. The device of claim 10, wherein the nose element comprise a curved portion.

13. The device of claim 11, wherein the front edge and the curved portion aid in removing the 3D printed element from the build plate of the 3D printer.

14. The device of claim 12, further comprising a thumb rest to provide stability when extending the nose element.

15. The device of claim 13, further comprising a body cover to shield the one or more springs and provide a surface area for the thumb rest.

16. The device of claim 14, further comprising one or more spring posts to each attach to each of the one or more springs.

17. The device of claim 15, further comprising a spring post tab to couple the one or more springs to each spring tab.
